(19) United States
(12) Patent Application Publication
(10) Pub. No.: US 2024/0171516 A1
(43) Pub. Date: May 23, 2024

(54) DISTRIBUTED NEURAL NETWORK ENCODER-DECODER SYSTEM AND METHOD FOR TRAFFIC ENGINEERING

(71) Applicant: HUAWEI TECHNOLOGIES CO., LTD., SHENZHEN (CN)

(72) Inventor: Omar Ahmad Mohammad ALHUSSEIN, Kanata (CA)

(73) Assignee: HUAWEI TECHNOLOGIES CO., LTD., SHENZHEN (CN)

(21) Appl. No.: 17/989,773

(22) Filed: Nov. 18, 2022

(51) Int. Cl. H04L 47/125; G06N 3/04; H04L 41/16; H04L 47/2441

(52) U.S. Cl. CPC H04L 47/125; G06N 3/0454; H04L 41/16; H04L 47/2441

(57) ABSTRACT

Methods and systems that enable communication network traffic engineering functions or application functions using combinations of neural network (NN) encoders and NN decoders are provided. A first network element has a NN encoder deployed thereat and receives input data based on which the NN encoder generates a latent representation. The latent representation is provided to a second network element that has a NN decoder deployed thereat and is configured to process the latent representation in accordance with a traffic engineering function to produce a traffic engineering output, which may be used to modify an operational state variable of the communication network. The input data are values of operational state variables of the communication network obtained at the first network element.

### CROSS-REFERENCE TO RELATED APPLICATIONS

This is the first application filed for this invention.

### TECHNICAL FIELD

The present invention pertains in general to communication networks and, in particular, to traffic engineering methods and systems in such networks.

### BACKGROUND

Network optimization and traffic engineering encompass various functions typically utilized in network operations at the traffic and resource levels. For example, an optimized traffic forwarding (or routing) function enables to steer traffic from source nodes to destination nodes while satisfying quality of service (QoS) requirements and other constraints. Other functions typically utilized in network optimization and traffic engineering include, for example, traffic forecasting, traffic classification, anomaly detection, traffic conditioning, queue management, and scheduling.

Such network functions require data from the substrate network for proper functioning. For example, a traffic forecasting function that uses a traffic forecasting algorithm for forecasting traffic volume and behavior for certain nodes or flows requires time-related data obtained from the nodes or flows. Additionally, the time-related data will typically be in relation to certain features of the nodes or flows. As another example of a network function there is a packet-level function, such as rate shaping and scheduling function, which also requires time-based data from the substrate network. The time resolution of the data obtained from the network typically matches the time basis at which the function operates. For example, packet-level network functions, such as rate shaping and scheduling, typically operate at finer time granularity (e.g., picoseconds to milliseconds), whereas a traffic forecasting network function typically operates at a coarser time granularity (e.g., seconds to hours).

Current network operation and traffic engineering functions rely on well-defined input data associated with metrics from the network and are typically implemented using either optimization methods or machine learning. For example, for a traffic forecasting network function, the input data may include an average number of packets every 5 minutes collected over 10 hours, and an average packet size every 5 minutes collected over 10 hours.

Determining the data and features required from the network, identifying the corresponding relevant (e.g., statistical) information to be extracted therefrom and determining a representation of such information are needed for proper functioning of each network operation and traffic engineering function. Obtaining and processing such data and features can be challenging and resource-consuming. Therefore, improvements in network traffic engineering are desirable.

This background information is provided to reveal information believed by the applicant to be of possible relevance to the present invention. No admission is necessarily intended, nor should be construed, that any of the preceding information constitutes prior art against the present invention.

### SUMMARY

Embodiments of the present disclosure provide methods and systems that enable communication network traffic engineering or application functions using combinations of neural network (NN) encoders and decoders.

According to an aspect of the present disclosure, there is provided a communication network that comprises a first network element that has a NN encoder. The NN encoder is configured to obtain, from the first network element, input data and to process the input data to obtain a latent representation of the input data. The input data are values of operational state variables of the communication network obtained at the first network element. The communication network also comprises a second network element configured to obtain the latent representation from the first network element. The second network element has a NN decoder configured to process the latent representation in accordance with a traffic engineering (TE) function to obtain a TE output.

In some embodiments, the operational state variables of the communication network include at least one of: an availability of computing resources in the communication network, a transmission bit rate in the communication network, a packet size of packets transmitted in the communication network, a utilization of a link in the communication network, a delay in a flow in the communication network, a delay in a link of the communication network, a feature obtained from a packet header, a metric obtained from a packet header, a data flow, and a traffic flow.

In some embodiments, the second network element is configured to modify at least one of the operational state variables of the communication network in accordance with the TE output.

In some embodiments, the TE output includes at least one of: a prediction of traffic in the communication network, the prediction of the traffic including a prediction of one or more of the operational state variables, a classification of the traffic in the communication network, the classification of the traffic including a classification of the at least one of the operational state variables, traffic forwarding settings of the communication network, nodal traffic control settings related to at least one of traffic conditioning, queue management, and scheduling of the communication network, an anomaly in the communication network, and a recommendation of a setting of a parameter of the communication network.

In some embodiments, the latent representation is an initial latent representation, and the communication network comprises additional network elements each having a respective additional NN encoder configured to obtain, from a respective additional network element, an additional latent representation of respective additional input data. The respective additional input data is related to additional values of operational state variables of the communication network obtained at the respective additional network element. The second network element is configured to obtain the additional latent representations from the additional network elements. The second network element is configured to process the additional latent representation and the initial representation in accordance with the TE function to obtain the TE output. In some embodiments, the second network element is configured to obtain a concatenation of the initial latent representation with the additional latent representations, and the second network element is configured to process the concatenation in accordance with the TE function to obtain the TE output.

In some embodiments, the communication network is an access network or a core network, the first network element is one of: a user equipment, an access network equipment and a core network equipment, and the decoder network element is one of: another user equipment, an access network equipment, and a core network equipment.

In accordance with another aspect of the present disclosure, there is provided a method, comprising, at a first network element a communication network, obtaining a latent representation from a second network element of the communication network, the latent representation representing input data obtained at the second network element, the input data being values of operational state variables of the communication network. The method further comprises processing the latent representation in accordance with a traffic engineering (TE) function to obtain a TE output.

In some embodiments of the method, the operational state variables of the communication network include at least one of: an availability of computing resources in the communication network, a transmission bit rate in the communication network, a packet size of packets transmitted in the communication network, a utilization of a link in the communication network, a delay in a flow in the communication network, and a delay in a link of the communication network.

In some embodiments, the first network element is configured to modify at least one of the operational state variables of the communication network in accordance with the TE output.

In some embodiments, processing the latent representation in accordance with the TE function to obtain a TE output includes processing the latent representation in accordance with the TE function to obtain at least one of: a prediction of one or more of the operational state variables, a classification of at least one of the operational state variables, and a recommendation of a setting of a parameter of the communication network.

In some embodiments, the latent representation is an initial latent representation and the method further comprises, at the first network element of the communication network: obtaining additional latent representations from respective additional network elements of the communication network, the additional latent representations representing respective additional input data obtained at the respective additional network elements, the additional input data being additional values of operational state variables of the communication network. Processing the initial latent representation in accordance with the TE function to obtain the TE output includes processing the additional latent representations and the initial latent representation in accordance with the TE function to obtain the TE output. In some embodiments, the method further comprises obtaining a concatenation of the initial latent representation with the additional latent representations, wherein processing the additional latent representations and the initial latent representation in accordance with the TE function to obtain the TE output includes processing the concatenation in accordance with the TE function to obtain the TE output.

In some embodiments, the input data includes at least one of sensing data generated by a sensor coupled to the communication network and analytics data generated by an analytics module coupled to the communication network.

In a further aspect, the present disclosure provides a method, comprising, at a first network element of a communication network, obtaining input data of the communication network, the input data being values of operational state variables of the communication network. The method further comprises encoding, using a neural network (NN) encoder, the input data to obtain a latent representation and providing the latent representation to a second network element of the communication network, the second network element configured to process the latent representation, with a NN decoder, in accordance with a TE function to obtain a TE output.

In some embodiments, the operational state variables of the communication network include at least one of: an availability of computing resources in the communication network, a transmission bit rate in the communication network, a packet size of packets transmitted in the communication network, a utilization of a link in the communication network, a delay in a flow in the communication network, and a delay in a link of the communication network. In some embodiments, the latent representation is an initial latent representation, and the method further comprises, at additional network elements of the communication network: obtaining additional input data of the communication network, the additional input data being additional values of operational state variables of the communication network. The method further comprises encoding, using respective additional (NN) encoders, the additional input data to obtain additional latent representations and providing the additional latent representations to the second network element of the communication network, the second network element configured to process the additional latent representation and the initial latent representation, with the NN decoder, in accordance with the TE function to obtain the TE output. In some embodiments, the second network element is configured to obtain a concatenation of the initial latent representation with the additional latent representations, the second network element being configured to process the additional latent representation and the initial latent representation, with the NN decoder, in accordance with the TE function to obtain the TE output includes the second network element being configured to process the concatenation, with the NN decoder, in accordance with the TE function to obtain the TE output.

In yet another aspect of the present disclosure, there is provided a tangible, non-transitory computer-readable medium having stored thereon instructions to be performed by a processor to perform the actions of any of the aforementioned methods.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a schematic of an encoder-decoder structure, according to an embodiment of the present disclosure.

FIG. 2A illustrates a schematic of an encoder-decoder system, according to an embodiment of the present disclosure.

FIG. 2B illustrates a schematic of an encoder-decoder system, according to another embodiment of the present disclosure.

FIG. 3A illustrates flowchart of a method for obtaining and transferring features needed for a TE function using an encoder-decoder system, according to an embodiment of the present disclosure.

FIG. 3B illustrates flowchart of a method for concatenating latent representations, according to an embodiment of the present disclosure.

FIG. 4 illustrates an encoder-decoder system deployed in a network, according to an embodiment of the present disclosure.

FIG. 5 illustrates an encoder-decoder system deployed in a network, according to another embodiment of the present disclosure.

FIG. 6 illustrates an encoder-decoder system deployed in a network, according to another embodiment of the present disclosure.

FIG. 7A illustrates a flowchart of a method for deploying an encoder-decoder system by an orchestrator, according to an embodiment of the present disclosure.

FIG. 7B illustrates a flowchart of a method for deploying an encoder-decoder system by an orchestrator, according to another embodiment of the present disclosure.

FIG. 8 illustrates a flowchart of a method for training of an encoder-decoder system, according to an embodiment of the present disclosure.

FIG. 9 illustrates a schematic structural diagram of an encoder-decoder system architecture, according to an embodiment of the present disclosure.

FIG. 10 illustrates structural hardware diagram of an AI chip, according to an embodiment of the present disclosure.

FIG. 11 illustrates an apparatus provided in accordance with an embodiment of the present disclosure.

It will be noted that throughout the appended drawings, like features are identified by like reference numerals.

### DETAILED DESCRIPTION

The present disclosure provides methods and systems for transferring features needed for enabling traffic engineering (TE) functions in a network. Non-limiting examples of such TE functions include: traffic prediction, traffic forwarding, traffic classification, scheduling and queuing, traffic conditioning, anomaly detection and other network functions implementable in the network. In some embodiments, a TE function relies on receiving data related to various features representative of or related to network traffic at network elements (e.g., network switches, commodity servers, cloud nodes) of a communication network.

In the context of the present disclosure, features are related to or representative of operational network state variables, some or all of which may be needed for at least one traffic engineering network function. The features may be related to or representative of network resources, (e.g., classes of) network traffic, or both. Non-limiting examples of features include: link bandwidth, measured delay and buffer space of a network element, available computational resources of a network element, measured delay, bit rate, packet rate of a certain network element or traffic flow(s), a transmission bit rate in the communication network, a packet size of packets transmitted in the communication network, a utilization of a link in the communication network, a delay in a flow in the communication network, and a delay in a link of the communication network. Generally, the features related to or representative of operational state variables may include features/metrics obtained (extracted) from packet headers, flows, and any other suitable measurements. As an example, when a decoder needs to predict whether a flow is delay sensitive or delay insensitive or, when a decoder needs to predict when traffic will be below a predefined congestion level or above the predefined congestion level, then some or all of the above mentioned operational state variables may be needed. Non-limiting examples of communication networks include the Internet, core networks and access networks.

In embodiments of the present disclosure, a distributed neural network encoder-decoder system is deployed in the (communication) network. The encoder-decoder system may utilize so called split learning to obtain features or data related to features needed for each of at least one TE function. The features may be obtained (or received) by each encoder deployed at a respective encoder network element in the network. The features obtained by each encoder may be referred to as input data and include some or all of available features at the respective encoder network element. The respective encoder network element is associated with at least a data plane traffic. The input data are related to operational state variables in the network, such as bit rate, packet size, utilization of link, measured delay of flow or link. The input data or data is processed (e.g. encoded by each encoder) and transferred (or transmitted, sent) across the network to be used to support (or enable, output) TE functions in the network. Processing the input data may include substantially automatically (e.g. after a corresponding machine learning training phase) selecting, by an encoder, from the input data those TE function features that are needed for a specific (at least one) TE function while generating a latent representation of the TE function features using neural network (NN) layers of the encoder. In other words, the encoder receives the input data at the respective encoder network element, automatically (following machine learning) processes the input data to generate (or output) a latent representation that represents the TE function features, thereby filtering out non-important (i.e. not needed, not relevant for each of at least one TE function) input data and representing relevant or selected features (i.e. those needed for at least one TE function) as the latent representation.

In embodiments, the latent representation is sent, by each representative encoder network element, to some or all of at least one decoder network element, each decoder network element having a decoder deployed thereat. A decoder receives the (at least one) latent representation and processes or decodes (each of) the received latent representation to output (e.g. perform or enable) at least one TE function.

In embodiments, the TE function output by the decoder may be based on the TE function features the latent representation is representative of.

In embodiments, more than one TE function may be associated with an output by one decoder.

In embodiments, a TE function may be a combination of individual TE functions.

In embodiments, an encoder-decoder system includes at least one (neural network or NN) encoder and at least one NN decoder. The encoder-decoder system may include a plurality of encoders deployed in the network. Each encoder is associated with and processes or encodes (e.g. periodically, with predetermined frequency) some or all input data from at least one associated or respective network element among a plurality of network elements (e.g., a network switch, a commodity server, a cloud node). Each encoder may obtain (e.g. receive, collect) some or all the input data related to or including features from its associated (or respective) network element. The encoder processes the obtained input data. Such processing may include selecting (e.g., filtering) TE function features required for each (of at least one) specific TE function from the input data by generating a latent representation of the TE function features.

In embodiments, all NN layers of an encoder may be implemented or deployed at a single respective encoder network element. In an embodiment, the respective encoder network element may receive data from other one or more network elements.

In embodiments, a respective encoder network element may not accommodate or host all n encoder NN layers, for example, due to insufficient resources (e.g. processing, memory, storage, computational, energy). In embodiments, one or more encoder NN layer (of the total of n encoder NN layers) of a same encoder may be implemented at another network element. In such case, a latent representation may be output at any hidden or intermediate encoder NN layer n-x, and transmitted to the other network element hosting the remaining x encoder NN layers. Any x number of encoder NN layers may be deployed at the other at least one network element. Such split encoder NN layers include the deepest or last NN layers of the encoder. The so-called intermediate latent representation generated at n-x encoder NN layer would be less encoded or compressed (or include more information or data representative of features) than the latent representation generated at encoder NN layer n.

In an embodiment, the last x encoder NN layers may be deployed at a network element hosting a decoder associated with the encoder (i.e. receiving the latent representation generated by the encoder). Such configuration may, for example, contribute to reduced resource consumption cost associated with transmitting the latent representation since the last x encoder NN layers are processed at the same network element as the decoder receiving the latent representation and, therefore, does not require transmission between separate network elements.

In embodiments, the encoder-decoder system includes at least one (neural network or NN) decoder. Each decoder is configured (e.g. trained) to receive at least one latent representation and output (e.g., perform) at least one TE function based, for example, TE function features encoded in the at least one latent representation. For example, a decoder may be similar to a traffic forecasting module, outputting a traffic forecasting TE function based on received latent representation (or TE function features encoded therein).

In an embodiment, the decoder network element may receive more than one latent representation from corresponding more than one encoder (via respective network elements). In such case, (e.g., predetermined number of) received latent representations (e.g., over a predetermined time period) may be concatenated or otherwise similarly combined or fused into a single latent representation before being processed by the decoder. Such concatenating may be performed, for example, by the accordingly configured respective decoder network element, the decoder, a concatenating module deployed at the decoder network element, or a combination thereof.

In some embodiments, a decoder may output more than one TE function. Each TE function output by the same decoder may rely on substantially the same output features. In one example, a TE function A may rely on (or need, require) a set of TE function features A, and a TE function B may rely on (or need, require) a set of TE function features B. The TE function features B may be a subset of the TE function features A. The TE function features B may include some, all, or none of the TE function features A. A decoder outputting more than one associated TE function may receive a (e.g. concatenated) latent representation that includes encoded TE function features for each associated TE function.

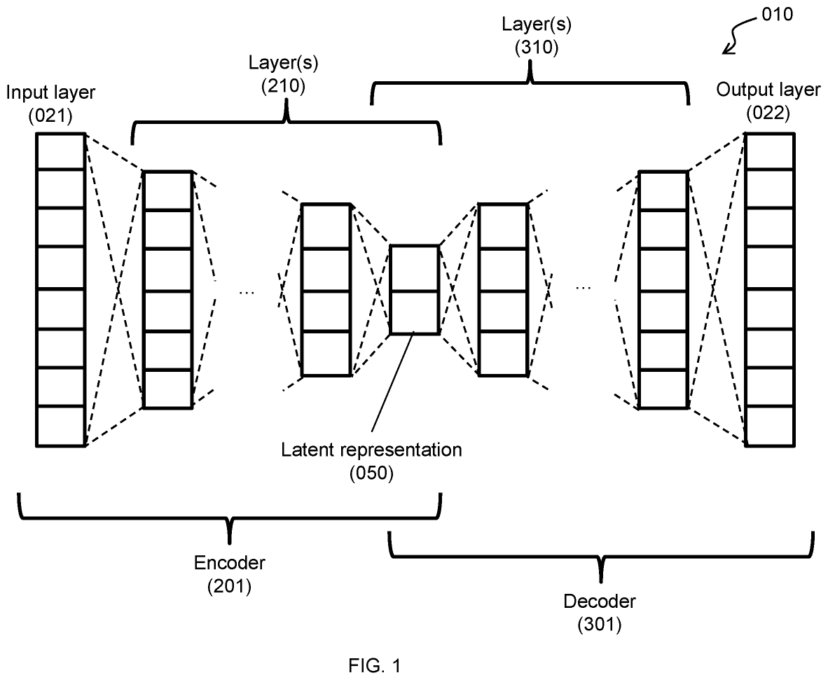

FIG. 1 illustrates a schematic of an encoder-decoder structure 010. An encoder 200 includes a first layer, which is an input layer 021, and n hidden encoder neural network (NN) layers 210. When the encoder processes (e.g. encodes) the input data provided or received at the input layer 021 using all the encoder layers (i.e. input layer 021 and hidden layers 210) the encoder 201 generates or outputs a latent representation 050 (also known as a code, an embedding, encoded data) of the TE function features that include some or all of the input data. A decoder 301, comprised of m hidden decoder NN layers 310 and an output layer 022, receives and processes the latent representation 050 to output (i.e. enable, perform) a TE function (e.g. output a prediction, a classification, or a recommendation TE function) 022. Such an encoder-decoder structure 010 may be trained (e.g. via machine learning, deep learning, deep reinforcement learning) to select (e.g. filter out from input data) TE function features for at least one TE function while generating the latent representation 050. The decoder 301 outputs at least one TE function at the output layer 022. In some embodiments, the input data may include at least one of sensing data generated by a sensor coupled to the communication network and analytics data generated by an analytics module coupled to the communication network.

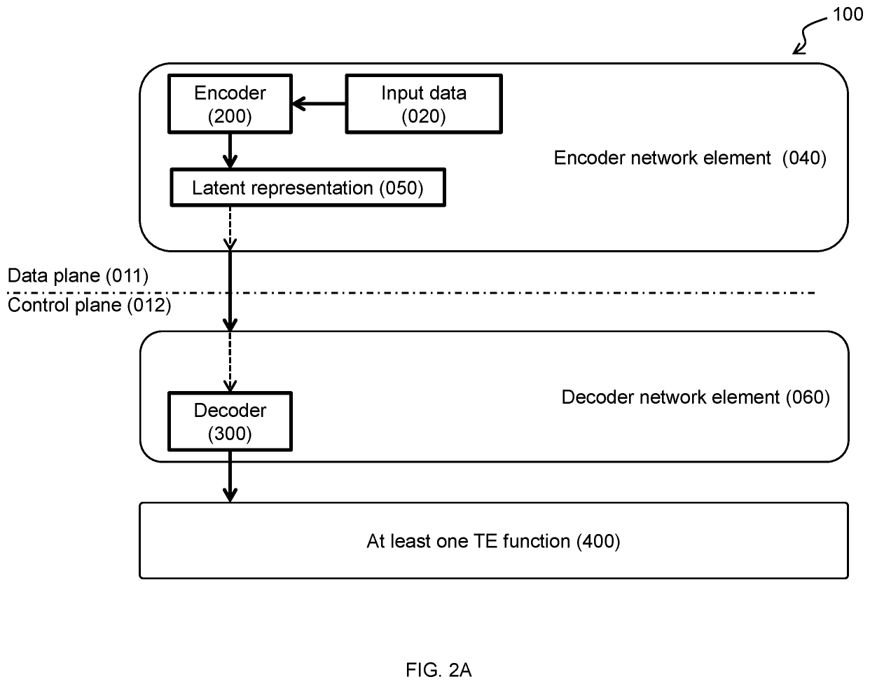

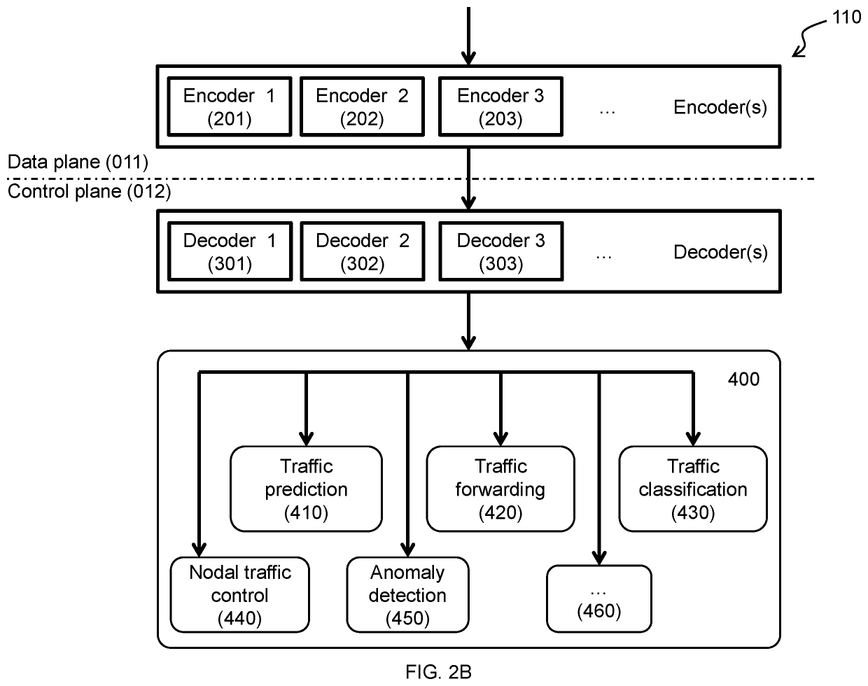

FIG. 2A illustrates a schematic of an encoder-decoder system 100 including an encoder 200 and a decoder 300, according to an embodiment of the present disclosure. In the system 100, the encoder 200 is deployed at an encoder network element 040. Correspondingly, the encoder network element 040 hosts the encoder 200. The encoder is typically deployed at or in a respective (or encoder) network element that forwards (i.e., receives or sends) data plane 011 type of traffic. In some embodiments, an encoder network element may include data plane elements or components, control plane elements or components, or both. In some embodiments, as described elsewhere herein, an encoder may be divided (or split), and one or more encoder NN layers may be deployed at other one or more network elements. The encoder 200 receives input data 020 at (or obtains input data 020 from) its respective encoder network element 040 and processes (e.g., encodes) the input data to generate or output a (e.g. respective or associated) latent representation 050. The latent representation 050 is communicated (e.g., provided, transmitted, sent) by the respective encoder network element 040 to the decoder 300 or to a decoder network element 060 having the decoder 300 deployed thereat. Correspondingly, the decoder network element 060 hosts the decoder 300. The decoder network element 060 is typically associated with control plane 012 traffic in the network. The decoder 300 is configured to process the latent representation 050 to output at least one TE function 400, as detailed elsewhere herein.

FIG. 2B illustrates a schematic of an encoder-decoder system 110, according to an embodiment of the present disclosure. The system 110 includes a plurality of encoders (e.g., encoder 1 201, encoder 2 202, encoder 3 203). The encoders of the plurality of encoders 200 are deployed at various associated or respective encoder network elements (not shown), described elsewhere herein. The encoders of the plurality of encoders 200 are typically deployed at or in network elements that forward (i.e., receive or send) data plane 011 type of traffic.

In some embodiments, an encoder network element may include data plane elements or components, control plane elements or components, or both. In some embodiments, as described elsewhere herein, an encoder may be divided (or split), and one or more encoder NN layers may be deployed at other one or more network elements. Each encoder receives input data at its respective encoder network element and processes (e.g. encodes) the input data to generate or output a (respective or associated) latent representation.

As further illustrated in FIG. 2B, latent representations are communicated (e.g. transmitted, sent) by each respective encoder network element to a group of decoders or to each respective at least one decoder network element having a respective decoder deployed thereat (e.g. decoder 1 301, decoder 2 302, decoder 3 303). Each decoder of the group of decoders is configured to process latent representations to output, at a decoder output layer, at least one TE function 400. The TE function 400 may be a traffic prediction 410 function, a traffic forwarding 420 function, a traffic classification 430 function, a nodal traffic control 440 function, an anomaly detection 450 function, or any other suitable TE function 460 (e.g. a traffic conditioning function). In some embodiments, the TE function 400 can be a combination of the aforementioned functions. TE functions output by multiple decoders may be different TE functions. Some decoders may output the same TE functions.

The nodal traffic control 440 function may include, for example, traffic conditioning, queue management, and scheduling. Settings of the nodal traffic control 440 function may include and allocated bandwidth or a priority level at different queues in a network element, or instructions to delay or drop certain flows until a traffic profile condition is met.

The anomaly detection 450 function may be configured to, for example, predict or detect a failure of a network element or, as another non-limiting example, predict or detect a change (an unexpected change) in an operational state variable (e.g., a utilization level of link).

As will be understood by the skilled worker, embodiments of the present disclosure may be deployed in core networks and/or in access networks.

For architectures involved in core networks (or wired networks), encoders (or the first network element in embodiments of the present disclosure) may be implemented in network switches, routers, middleware components, or other computing elements or servers including commercial-off-the-shelf computing hardware platforms and specialized hardware computing platforms. Each decoder may be trained to perform a network or application function (network or application functionality) such as, but not limited to, traffic prediction, traffic forwarding, anomaly detection, packet classification, or input data reconstruction. Multiple encoders may be coupled to a single decoder to provide a network or application function. The decoder (or the second network element in embodiments of the present disclosure) may be deployed in a network element such as network switch, router, middleware component, or other computing elements and servers including commercial-off-the-shelf computing hardware platforms and specialized hardware computing platforms. An example of traffic prediction-based encoder-decoder scenario is given in one of the embodiments.

For architectures involved in access networks (or wireless networks), encoders (or the first network element in embodiments of the present disclosure) and/or decoders (or the second network element in embodiments of the present disclosure) may be implemented in user equipment (e.g., mobile devices) or access network node (e.g. base stations), wherein the access network node may be, baseband units, mobile-edge and data center servers or computing elements, including commercial-off-the-shelf computing hardware platforms and specialized hardware computing platforms. Decoders may be trained to perform a network or application functionality (network or application function) such as mobility prediction, power prediction/estimation, mm-wave based throughput prediction, traffic prediction, packet scheduling.

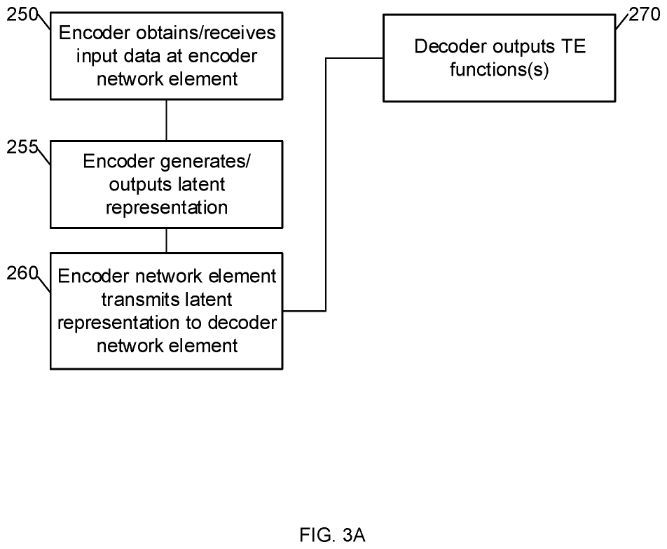

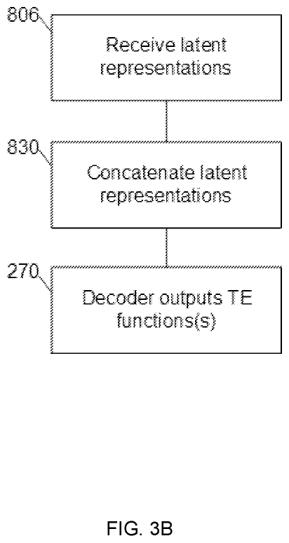

FIG. 3A illustrates a flowchart of an embodiment of a method for obtaining and transferring features for a TE function using an encoder-decoder system, in accordance with the present disclosure. At action 250, an (or each encoder) encoder obtains or receives input data from or at an associated or respective encoder network element. At action 255, the encoder processes (e.g. encodes, filters out) the input data obtained at action 250 to generate or output a latent representation of TE function features. At action 260, the latent representation is communicated (or transmitted, sent) by the encoder network element to each associated decoder network element having respective decoder deployed thereat. A decoder is configured (e.g. via training) to act on or process the latent representation to output, at action 270, at least one TE function.

FIG. 3B illustrates a flowchart of an embodiment of a method for concatenating latent representations, in accordance with the present disclosure. A decoder network element may receive more than one latent representation at action 806 from respective more than one encoder via their respective network elements. Multiple (i.e. two or more) latent representations may be concatenated at action 830 or otherwise similarly combined or fused into a single so-called concatenated latent representation before processing by the decoder. Such concatenating at action 830 may be performed, for example, by the accordingly configured respective decoder network element, the decoder, a concatenating module deployed at the decoder network element, or a combination thereof. The decoder then processes the concatenated latent representation and outputs at action 270 at least one TE function.

In embodiments, an encoder-decoder system may include an orchestrator. The orchestrator may configure (e.g. via training) the encoder-decoder system. The orchestrator may deploy the trained encoder-decoder system in the network.

The orchestrator may facilitate a training phase (e.g., using machine learning, deep learning) of the encoder-decoder system. The training phase may include the orchestrator communicating to respective network elements hosting the encoders, a set of features required for each of at least one TE function. In response, each respective network element may send (or provide) input data to the encoder deployed thereat. The encoder may use the communicated set of features in processing the input data to output a latent representation of TE function features (i.e. of the communicated set of features). The orchestrator may configure the training phase to be implemented, for example, as a centralized training, as a distributed training, or another training approach utilized in training neural networks. The orchestrator may determine the distribution of encoders and decoders at associated (or respective) network elements based, for example, at least in part on resources available to an encoder or decoder at the associated (or respective) network element. Such resources may include, for example, resources related to computing, storage, memory, transmission, input data, processing, or energy. Such determining of the encoder-decoder distribution at respective network elements may include minimizing the impact of storage and computational resources required by the encoder or decoder at the respective network element on other functions or operations associated with the respective network element. If the respective network element hosting an encoder has insufficient resources to enable the encoder to output a latent representation at the last encoder NN layer n, then the orchestrator may distribute encoder NN layers at two or more network elements.

In embodiments, the orchestrator can determine a set of input data to be input (or sent, fed, provided) to each encoder at the respective encoder network elements of the encoder-decoder system.

In embodiments, the orchestrator may determine decoder placement, or decoder network elements to host respective decoders. In embodiments, the orchestrator may determine encoder placement, or encoder network elements to host respective encoders.

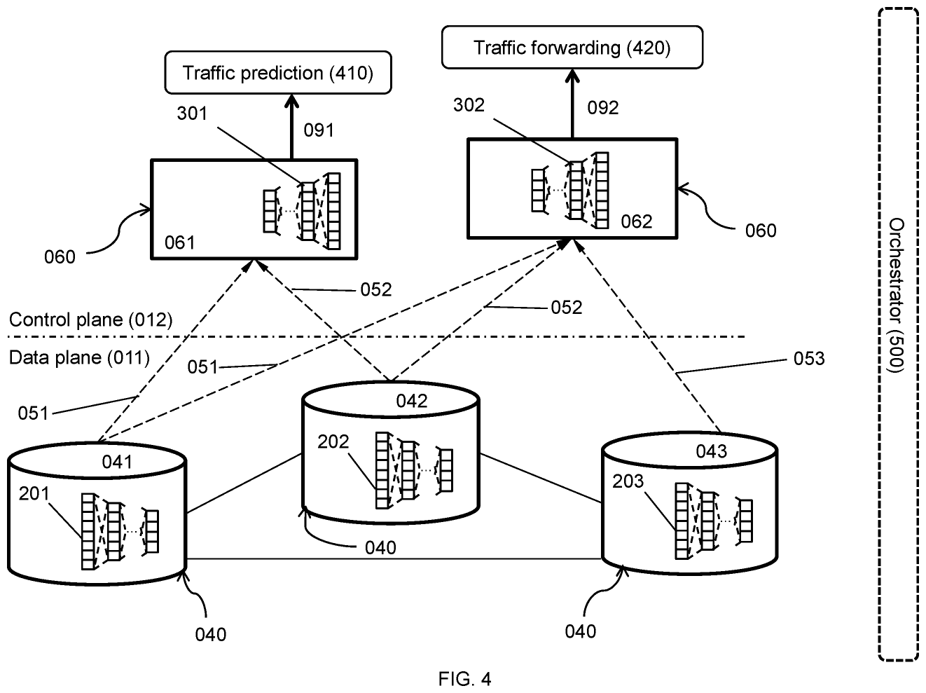

FIG. 4 illustrates an encoder-decoder system deployed in a network, according to an embodiment of the present disclosure. A first encoder 201 is deployed at a first encoder network element 041 (e.g. a switch), a second encoder 202 is deployed at a second encoder network element 042 (e.g. a switch), and a third encoder 203 is deployed at a third encoder network element 043 (e.g. a switch). Each encoder network element 040 is in the data plane 011 or has at least a component or feature involved in the data plane data flow. However, some or all encoder network elements may be in control plane 012 or may have features or components involved in control plane data flow. Although three instances of encoders 201, 202, 203 and encoder network elements 040 are illustrated, it should be understood that in other similar embodiments any quantity of encoders and respective encoder network elements may be present.

As further illustrated in FIG. 4, each encoder communicates its generated latent representation to all or some decoders deployed at respective decoder network elements 060 in the encoder-decoder system. Each decoder network element 060 is in the control plane 012 or has at least a component or feature involved in the control plane data flow. A first latent representation 051 output by the first encoder 201 is communicated to a first decoder 301 deployed at a first decoder network element 061 and to a second decoder 302 deployed at a second decoder network element 062. Similarly, a second latent representation 052 output by the second encoder 202 is communicated to the first decoder 301 and to the second decoder 302. As shown, a third latent representation 053 output by the third encoder 203 is communicated only to the second decoder 302. As a result, the first decoder 301 receives two latent representations 051, 052, while the second decoder 302 receives three latent representations 051, 052, 053.

In embodiments, each (of at least one) TE function output by a decoder is based on the TE function features encoded in all (of at least one) latent representations the decoder receives. Latent representations received by the decoder may be representative of more features than those needed for a given TE function. For example, as illustrated in FIG. 4, the first decoder 301 may output 091 a traffic prediction function 410 based on or using the first latent representation 051 and the second latent representation 052. The second decoder 302 may output 092 a traffic forwarding function 420 based on or using the first latent representation 051, the second latent representation 052 and the third latent representation 053.

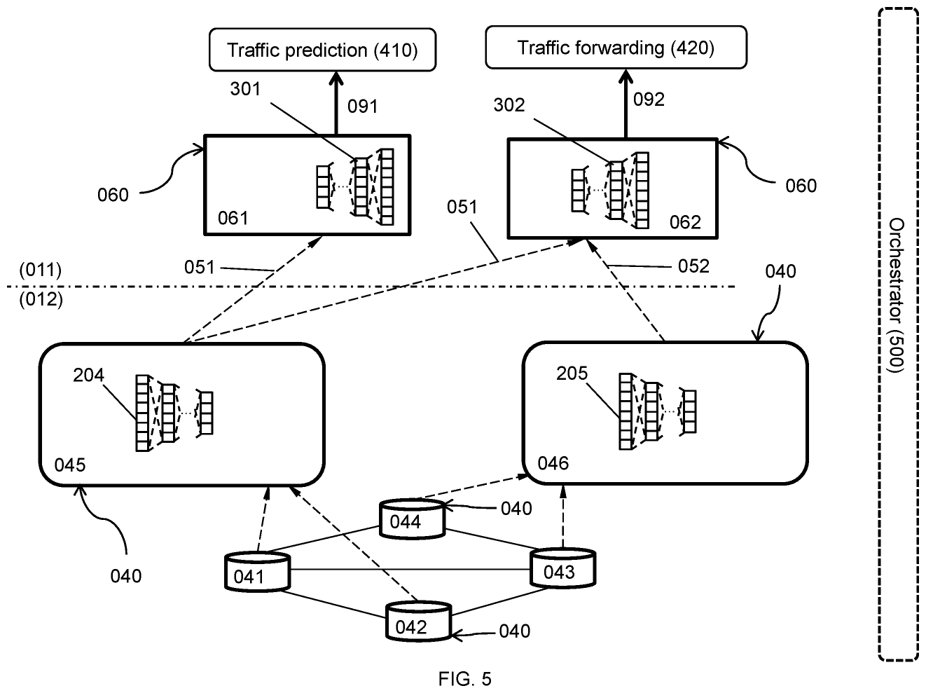

FIG. 5 illustrates an encoder-decoder system deployed in a network, according to another embodiment of the present disclosure. A first encoder 204 and a second encoder 205 are deployed at a first encoder network element 045 and a second encoder network element 046, respectively. The first and second encoder network elements 045, 046 may be, for example, commodity servers, cloud nodes, baseband units, or mobile edge commodity servers, and receive information (e.g. data) from some or all of the (e.g. associated) data plane network elements 040 (e.g. switches 041, 042, 043, 044). Although two instances of encoders 204, 205 and four instances of data plane network elements 041, 042, 043, 044 are illustrated, it should be understood that in other similar embodiments any quantity of encoders and network elements may be present. The first encoder 204 receives input data at the first encoder network element 045. The first encoder network element 045 receives data (e.g. representative of features) from two data plane network elements 041, 042. The second encoder 205 encodes some or all features from the second encoder network element 046. The second encoder network element 046 receives data (e.g., representative of features) from two data plane network elements 043, 044.

As further illustrated in FIG. 5, the first encoder 204 outputs a first latent representation 051 and the second encoder 205 outputs a second latent representation 052. Each encoder 204, 205 communicates, via its respective encoder network element 045, 046, its generated latent representation 051, 052 to at least some of the decoders 301, 302 deployed at their respective network elements 061, 062 in the encoder-decoder system. For example, the first decoder 301 receives, via its respective first decoder network element 061, only the first latent representation 051, while the second decoder 302 receives, via its respective second decoder network element 062, both the first and the second latent representation 051, 052. Each decoder 301, 302 is configured to process all the received latent representations to obtain TE function features needed for each associated (or respective) TE function 410, 420. For example, the first decoder 301 may output 091 a traffic prediction function 410 based on or using the first latent representation 051. Similarly, the second decoder 302 may output 092 a traffic forwarding function 420 from the first latent representation 051 and the second latent representation 052.

A non-limiting example of traffic forwarding is when a decoder is configured to generate a binary output for each link in the network, where “1” for a particular link indicates a flow is to pass that link. As another example, a decoder may output more explicit settings such as some or all of routing table entries of one or more network element.

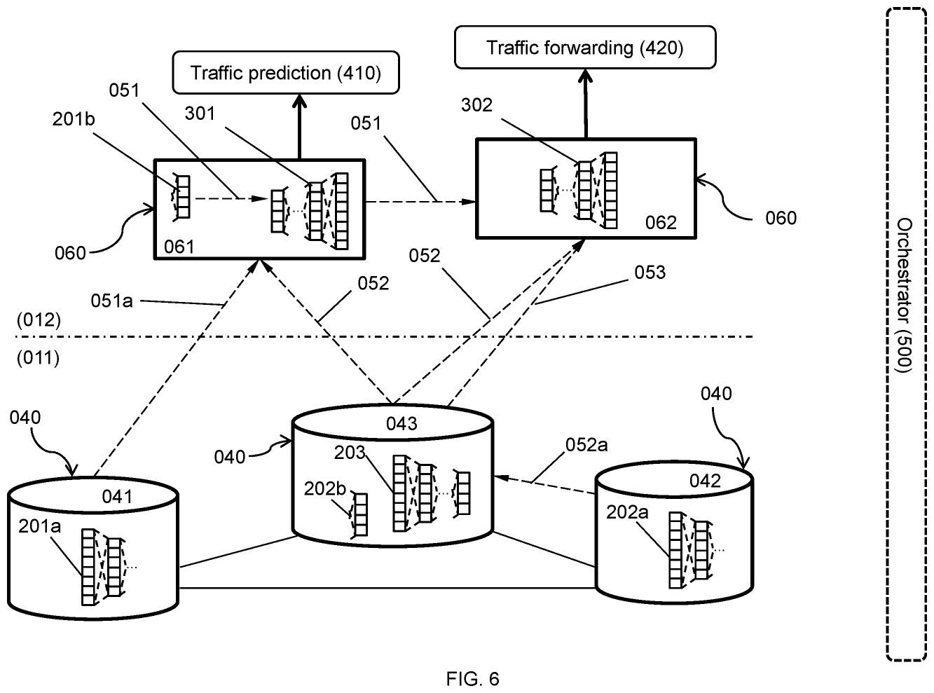

FIG. 6 illustrates an encoder-decoder system deployed in a network, according to another embodiment of the present disclosure. A network element at which an encoder is deployed may have insufficient resources to host all NN layers of an encoder. In such case, one or more encoder NN layers x may be deployed at another network element. For example, a first encoder having n encoder NN layers is divided or split such that n-x encoder NN layers 201a are deployed at the first encoder network element 041, and x encoder NN layers 201b are deployed at another network element, which in this case is a first decoder network element 061 hosting a first decoder 301. Here, the n-x layers 201a output a first so-called intermediate latent representation 051a generated. The first intermediate latent representation 051a is then sent by the first encoder network element 041 to the first decoder network element 061 where the remaining x encoder NN layers 201b are used to output the first latent representation 051. The first latent representation 051 is then received by the first decoder 301 and may be sent to a second decoder 302 (or the second decoder network element 062 thereof) if required or configured accordingly.

As further illustrated in FIG. 6, a second encoder having p encoder NN layers is divided or split such that p-y encoder NN layers 202a are deployed at a second encoder network element 042, and y encoder NN layers 202b are deployed at another network element, which in this case is a third encoder network element 043, which hosts a second decoder 203. Here, the second encoder p-y NN layers output a first so-called intermediate latent representation 052a. The first intermediate latent representation 051a is then sent by the second encoder network element 042 to the third encoder network element 043 where the remaining y encoder NN layers 202b are used to output the second latent representation 052. The second latent representation 052 is then sent by the third encoder network element 043 to the first decoder network element 061 and the second decoder network element 062. In addition to sending the second latent representation 052, the third encoder network element 043 may also be configured to send a third latent representation 053 output by the third encoder 203 deployed thereat, for example, to the second decoder network element 062 only, as shown.

In another example (not shown), NN layers of an encoder may be split between more than two network elements. Corresponding so-called intermediate latent representations output at each respective network element can be sent for further encoding to the next network element hosting further encoder NN layers, for example, in succession or predetermined order based on sequential order of the encoder NN layers. Therefore, a network element may be configured to host split encoder NN layers from one or more encoders and send corresponding latent representations or so-called intermediate latent representations to one or more decoders (or decoder network elements thereof) or other predetermined network elements hosting further NN layers of corresponding encoders, respectively.

The x encoder layers 201b are deployed at the network element 061. The same element 061 includes a first decoder 301. Thus, one or more encoder layer may be deployed at a same network element as the decoder receiving the latent representation generated by the (divided) encoder.

As further illustrated in FIG. 6, the first encoder part 202a is deployed at the network element 041 and the second encoder part B 202b is deployed at the network element 043 that includes the third encoder 203 in the data plane 011. Thus, one or more encoder layer may be deployed at another data plane network element.

As further illustrated in FIGS. 4, 5 and 6, the encoder-decoder system may include an orchestrator 500 deployed in the network. The orchestrator may facilitate or coordinate a training phase of the encoder-decoder system, as described elsewhere herein.

In embodiments, the orchestrator may not necessarily be involved in operation of the encoder-decoder system after training and deployment in the network. In some embodiments, the orchestrator may be involved in updates or maintenance of deployed encoder-decoder system. In some embodiments, the orchestrator may be configured to determine the set of features (input data) the encoders are to collect/receive/obtain. Additionally, in some embodiments, the orchestrator may be configured to deploy new types of TE functions as decoders. Further, in some embodiments, the orchestrator may be configured to deploy pre-trained encoders or decoders for new TE functions.

In embodiments, an orchestrator utilized for a training phase of the encoder-decoder system may determine if a network element has sufficient (e.g. computational, communication) resources for hosting all NN layers of an encoder. If the orchestrator determines that such resources may be insufficient, then the orchestrator may determine an optimum deployment of encoder NN layers between two or more network elements. Any additional network element where such divided or split encoder NN layers may be deployed may be in the control plane or the data plane. Some split encoder NN layers may be deployed at more than one additional network element.

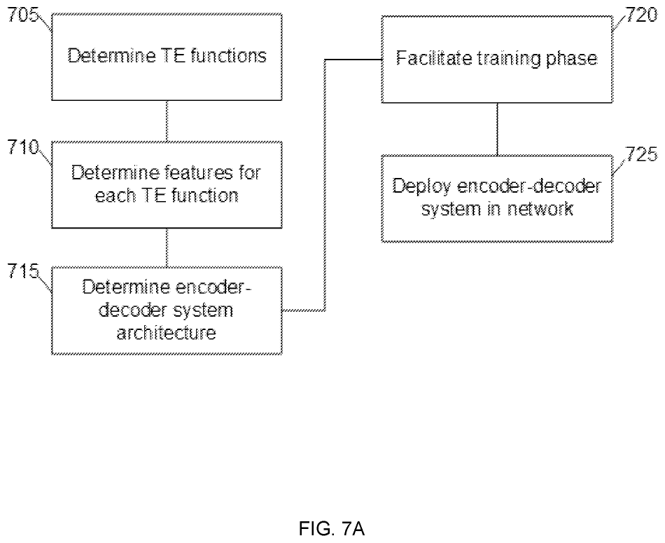

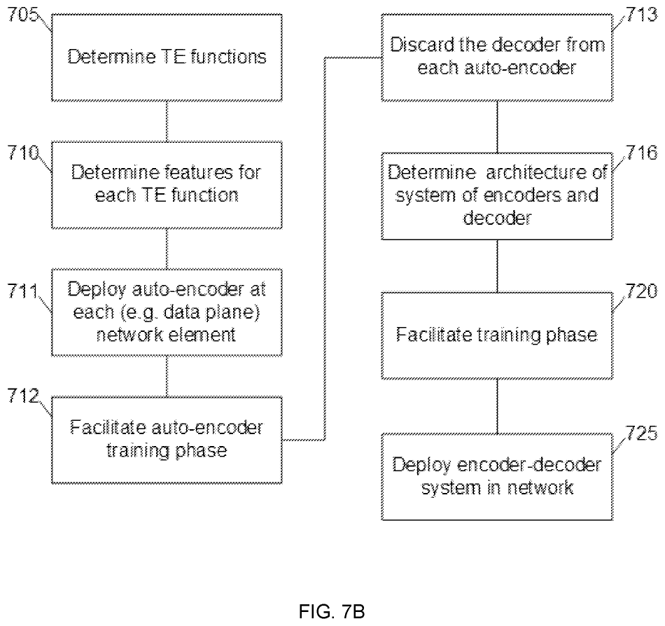

FIG. 7A illustrates a flowchart of an embodiment of a method for deploying an encoder-decoder system by an orchestrator, in accordance with the present disclosure. At action 705, the orchestrator determines (e.g., via a user input, via receiving from an external component, via retrieving from a memory) TE functions in a network. Such functions may include a forwarding engine, traffic forecasting, traffic classification, anomaly detection, etc. At action 710, the orchestrator determines (e.g., via a user input, via receiving from an external component, via retrieving from a memory) TE function features needed for each TE function in the network. At action 715, the orchestrator determines an encoder-decoder system architecture (e.g. how many encoders and decoders, network elements thereof, etc.) to be deployed in the network to obtain and transfer TE function features needed for supporting (or performing, enabling) TE functions in the network. Determining the architecture may include determining the quantity of respective network elements and the resources available at each network element for hosting decoders, encoders, and possible split encoder NN layers. Determining the architecture may include determining (e.g. based on input and output, network properties, network complexity) the quantity of encoders and decoders to deploy in the network and at which network elements to deploy them. Determining the architecture may include determining that a network element has sufficient resources for deployment or hosting of an encoder at that network element. Determining the architecture may include determining dividing (i.e. splitting) and deploying one or more NN layers of an encoder at another one or more respective network elements. Splitting of an encoder NN layers may be determined during a training phase implemented using combinatorial optimization or deep learning, for example. Determining the architecture may include determining which latent representations are to be sent by which encoders (or respective encoder network elements) to which decoders (or respective decoder network elements). Determining the architecture may include configuring network elements to host respective decoders, encoders, and encoder NN elements. Determining the architecture may include configuring respective elements to send latent representations (or so-called intermediate latent representation) output by respective encoders (or NN layers thereof) deployed thereat to one or more decoder network elements each hosting respective decoder deployed thereat. Determining the architecture may include configuring a (or each) decoder, a (or each) respective decoder network element, or both to concatenate received latent representations, as described elsewhere herein. Determining the architecture may include determining the type of neural network to be used as the encoder and the decoder, e.g., convolutional neural network, feedforward neural network, recurrent neural network, diffusion neural network, Variational neural network, or neural network with attention (also known as transformer neural networks).

As further illustrated in FIG. 7A, at action 720 the orchestrator facilitates a training phase, as described elsewhere herein. At action 725, the orchestrator deploys the trained encoder-decoder system in the network.

FIG. 7B illustrates a flowchart of an embodiment of a method for deploying an encoder-decoder system by an orchestrator, in accordance with the present disclosure. This embodiment includes actions 705 and 710 described elsewhere herein with regard to FIG. 7A. The method includes action 711 at which the orchestrator deploys auto-encoders (i.e. encoder and decoder pair where decoder output is substantially the same as encoder input) at each network element that receives, forwards (e.g. sends, transmits), or both, data plane traffic in the network (e.g. all network switches). At action 712, the orchestrator conducts (facilitates) an auto-encoder training phase which includes training (e.g., via deep learning) each auto-encoder to reconstruct, with sufficient and, for example, predetermined accuracy, input data, received and processed (e.g., encoded) by an encoder of the auto-encoder to output a latent representation, into an output generated by a decoder of the auto-encoder. Each auto-encoder may be trained until convergence, or until a predetermined reconstruction accuracy is reached by each auto-encoder. Following the auto-encoder training phase, at action 713 the orchestrator discards the decoder from each auto-encoder or deploys the decoder of each auto-encoder at a respective decoder network element determined to host the respective decoder. In such embodiment, each encoder is trained to process input data and output a latent representation of all input data without filtering or selecting of specific TE function features from the input data by the encoder. Such training may be associated with reduced training time (e.g., time to convergence) and lower (e.g., computing, communication) resource requirements. Such encoders trained as auto-encoders may be used in subsequent training (e.g., via bootstrapping) of the encoders to, for example, filter or select input data. Such encoders trained as auto-encoders may be subsequently trained with another (i.e., new) at least one decoder. Training of encoders using auto-encoders may allow any subsequent encoder-decoder training to be more resource and time-efficient (e.g., faster convergence) compared to similar encoder-decoder training without prior auto-encoder training.

As further illustrated in FIG. 7B, at action 716 the orchestrator determines an encoder-decoder system architecture (e.g., how many encoders and decoders, network elements thereof, etc.) to be deployed in the network to obtain and transfer TE function features needed for supporting (or performing, enabling) TE functions in the network. Determining the architecture at action 716 may include some or all features of action 715 described above in relation to FIG. 7A. The illustrative embodiment of FIG. 7B further includes actions 720 and 725 described elsewhere herein regarding relation to FIG. 7A.

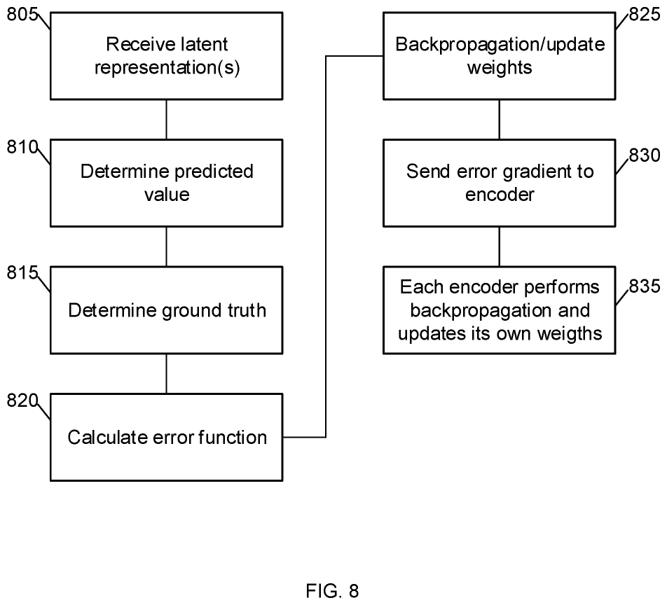

FIG. 8 illustrates a flowchart of an embodiment of a method for distributed (or split) training of an encoder-decoder system conducted (facilitated) by an orchestrator, in accordance with the present disclosure. It should be noted that such training may be implemented without an orchestrator, for example, by direct coordinating between respective encoder and decoder network elements configured accordingly (e.g., via user input). At action 805 (e.g., forward pass), a decoder receives latent representations from each encoder deployed in a network. At action 810, the decoder processes latent representations to generate or output predicted values or recommendation of at least one TE function. Action 810 may include concatenating some or all of the received latent representations, as described elsewhere herein. The decoder may optionally (i.e., if configured accordingly, for example, by the orchestrator) communicate the predicted values to the orchestrator for calculating an error function at action 820 described further herein. The predicted values may include TE function features that may partially or exactly match input data at an input layer of a corresponding (at least one) encoder. At action 815, each network element with an associated (or respective) encoder collects a ground truth and communicates the ground truth to the decoder or the orchestrator if the predicted values was communicated by the decoder to the orchestrator at action 810. The action 815 may be facilitated by the orchestrator by, for example configuring (e.g., instructing, requesting) each respective network element accordingly. The ground truth may include all input data at the corresponding encoder. At action 820, the decoder or the orchestrator calculates the error function (e.g., an error metric such as mean-square error) of the decoder, for example by subtracting the predicted value (expected traffic demand) from the ground truth (e.g., actual traffic demand). At actions 825, 830, 835, the orchestrator facilitates backpropagation across the network, where first the decoder performs backpropagation and update its own weights at action 825. Then, the decoder sends back to each encoder the gradient of error (e) with respect to the respective received latent representation or code (c) (e.g., ∂e/∂c) at action 830. At action 835, each encoder utilizes a received error gradient to perform backpropagation and update its own weights. Actions described above may be repeated until the error function is at or below a predetermined target value indicating completion of the training phase (i.e., until convergence). Such predetermined target value may be standard, may be automatically determined by the orchestrator, may be communicated (e.g. indicated, sent) to the orchestrator or each decoder from an external component (e.g. a user), or a combination thereof.

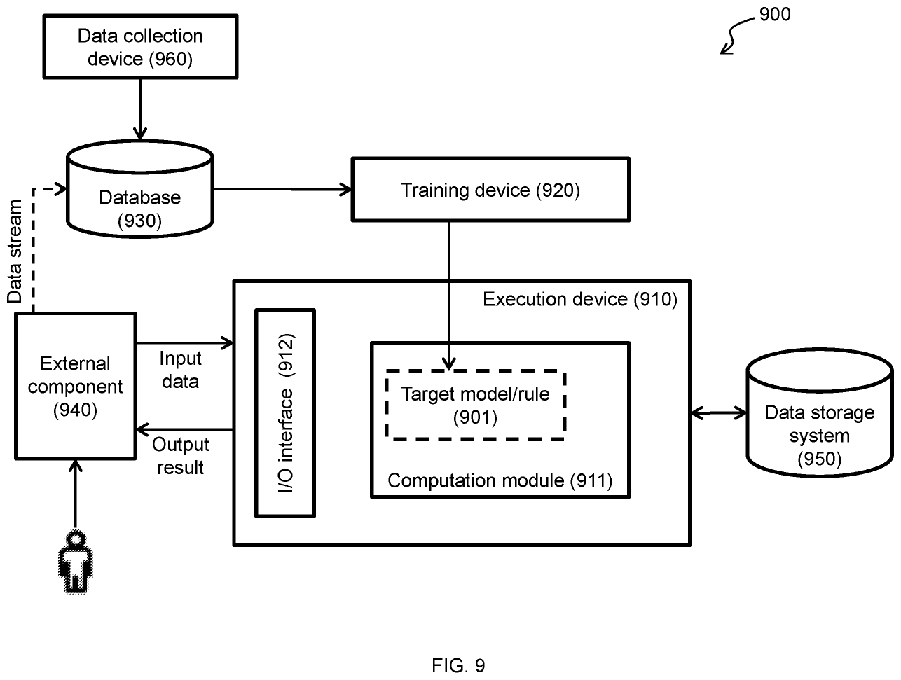

FIG. 9 is a schematic structural diagram of an encoder-decoder system architecture 900 according to an embodiment of the present disclosure. A data collection device 960 is configured to collect various data and store the collected data into a database 930. A training device 900 may generate a target model/rule 901 based on the data maintained in the database 930.

To enable the deep neural network (as represented by the encoder-decoder system of the present disclosure) to output a predicted value (e.g., a TE function output by a decoder, such as a network traffic demand prediction) that is as close to a truly desired value (i.e., ground truth, such as the actual network traffic demand) as possible, a predicted value of a current network and a truly desired target value may be compared, and a weight vector (as output by each NN layer) of each layer of the neural network is updated based on a difference between the predicted value and the truly desired target value. (It should be noted that there is usually an initialization process before a first update and a parameter is preconfigured for each layer of the neural network). For example, if the predicted value of a network is excessively high, then the weight vector may be continuously adjusted to lower the predicted value, until the neural network can predict the truly desired target value with sufficient certainty or accuracy. A loss (or error) function or an objective function can be predefined. The loss function and the objective function may be used to measure or calculate the difference between a predicted value and a target value. For example, a higher output value (i.e., loss) of a loss function indicates a greater difference between predicted and target value and training the deep neural network is a process of minimizing the loss.

The target module/rule (for example, desired policy) obtained by the training device 920 may be applied to different systems or devices, such as encoders and decoders of the encoder-decoder system. In FIG. 9, an execution device 910 is provided with an I/O interface 912 to perform data interaction with an external component 940. A “user” may input data to the I/O interface 912 by using the external component 940.

The execution device 910 may invoke data, code, and the like from a data storage system 950, and may store the data, an instruction, and the like into the data storage system 950.

A computation module 911 processes the input data by using the target model/rule 901. Finally, the I/O interface 912 returns a processing result to the external component 940 and provides the processing result to the user. More deeply, the training device 920 may generate corresponding target models/rules 901 for different targets based on different data, to provide a better result for the user.

In the example shown in FIG. 9, the user may manually specify data to be input to the execution device 910, for example, an operation in a screen provided by the I/O interface 912. In another example, the external component 940 may automatically input data to the I/O interface 912 and obtain a result. If the external component 940 automatically inputs data, authorization of a user associated with the external component 940 may need to be obtained. The user can specify a corresponding permission in the external component 940. The user may view, in the external component 940, the result output by the execution device 910. A specific presentation form may be display content, a voice, an action, and the like. In addition, the external component 940 may be used as a data collector to store collected data into the database 930.

In embodiments of the present disclosure, the encoder in deployed in an entity (and can be regarded as a separate neural network), and the decoder may be deployed in another entity (and can also be regarded as a separate neural network). Therefore, the elements of FIG. 9 can exist both in the encoder network entity and the decoder entity. The data collection device (960) in the encoder network element may collect raw input data, whereas the data collection device in the decoder network element may collect latent representation codes. There may be a training device 920 and an execution device 910 in each of the encoder network element and the decoder network element. The target model/rule in the encoder and decoder network element contains an encoder NN and a decoder NN, respectively. The output results (from the I/O interface 912) in the encoder corresponds to the latent codes which are to be sent to the decoder, whereas the output results (from the I/O interface 912) in the decoder network element may correspond to the prediction/classification of decoder NN. In a distributed/split mode of training, there may be a transfer of the error gradient back from decoder network element to encoder network element.

In some embodiments where centralized training is performed, an orchestrator described elsewhere herein may include some or all of the target model/rule 901, the execution device 910, the computation module 911, the I/O interface 912, the training device 920, the database 930, the data storage system 950, and the data collection device 960. In such embodiments, the target model/rule 901 may contain an encoder model and a decoder model, both of which may be trained jointly.

In some embodiments where split/distributed training is performed, all the components shown at FIG. 9 may be included in the encoder and in the decoder.

It should be noted that FIG. 9 is merely a schematic diagram of a system architecture according to an embodiment of the present disclosure. Position relationships between the device, the component, the module, and the like that are shown in FIG. 9 do not constitute any limitation. For example, in FIG. 9, the data storage system 950 is an external memory relative to the execution device 910. In another case, the data storage system 950 may be located in the execution device 910.

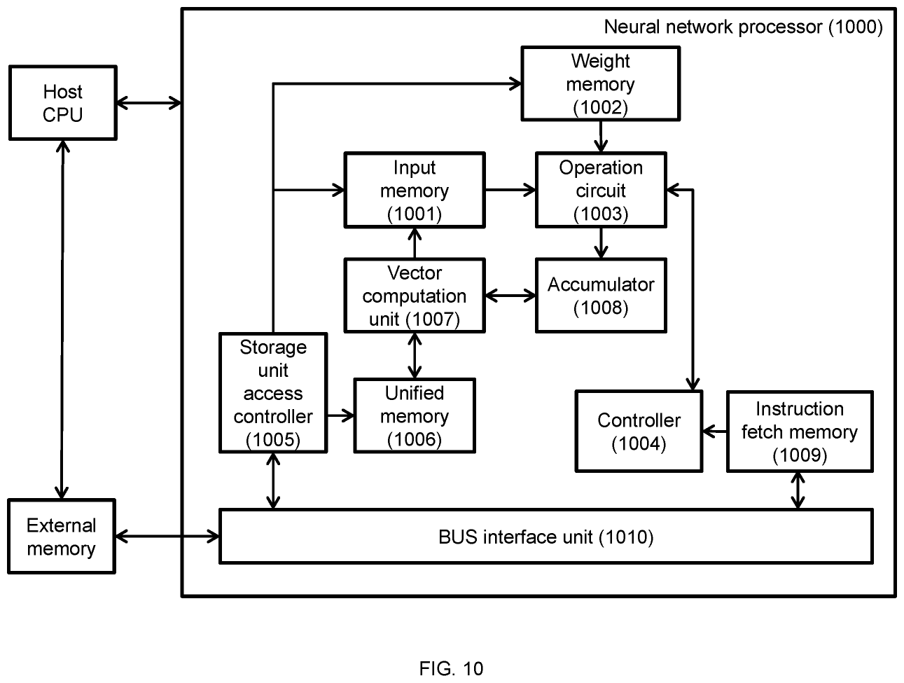

FIG. 10 is a structural hardware diagram of a (e.g. an Artificial Intelligence or AI) chip according to an embodiment of the present disclosure. The chip includes a neural network processor 1000. The chip may be provided in the execution device 910 shown in FIG. 9, to perform computation for the computation module 911. Alternatively, the chip may be provided in the training device 920 shown in FIG. 9, to perform training and output the target model/rule 901. The chip may be provided in network elements (e.g. network switches, network routers) associated with encoders to enable neural network functionality needed for the encoder-decoder system of the present disclosure.

The neural network processor 1000 may be any processor that is applicable to massive Exclusive Or (XOR) operations, for example, a neural processing unit (NPU), a tensor processing unit (TPU), a graphics processing unit (GPU), or the like. The NPU is used as an example. The NPU may be mounted, as a coprocessor, to a host CPU (host CPU), and the host CPU allocates a task. A core part of the NPU is an operation circuit 1003. A controller 1004 controls the operation circuit 1003 to extract matrix data from a memory and perform a multiplication operation.

In some implementations, the operation circuit 1003 internally includes a plurality of processing units (process engine or PE). In some implementations, the operation circuit 1003 is a bi-dimensional systolic array. In addition, the operation circuit 1003 may be a uni-dimensional systolic array or another electronic circuit that can implement a mathematical operation such as multiplication and addition. In some implementations, the operation circuit 1003 is a general matrix processor.

For example, it is assumed that there are an input matrix A, a weight matrix B, and an output matrix C. The operation circuit obtains, from a weight memory 1002, data corresponding to the matrix B, and caches the data in each PE in the operation circuit. The operation circuit obtains data of the matrix A from an input memory 1001, and performs a matrix operation on the data of the matrix A and the data of the matrix B. An obtained partial or final matrix result is stored in an accumulator 1008.

A unified memory 1006 is configured to store input data and output data. Weight data is directly moved to the weight memory 1002 by using a storage unit access controller (for example, direct memory access controller or DMAC) 1005. The input data is also moved to the unified memory 1006 by using the DMAC.

A bus interface unit (BIU) 1010 is configured to enable an Advanced eXtensible Interface (AXI) bus to interact with the DMAC and an instruction fetch memory (instruction fetch buffer) 1009. The BIU 1010 may be further configured to enable the instruction fetch memory 1009 to obtain an instruction from an external memory, and is further configured to enable the storage unit access controller 1005 to obtain, from the external memory, source data of the input matrix A or the weight matrix B.

The storage unit access controller (for example, DMAC) 1005 is mainly configured to move input data from an external Double Data Rate (DDR) memory to the unified memory 1006, or move the weight data to the weight memory 1002, or move the input data to the input memory 1001.

A vector computation unit 1007 includes a plurality of operation processing units. If needed, the vector computation unit 1007 performs further processing, for example, vector multiplication, vector addition, an exponent operation, a logarithm operation, or magnitude comparison, on an output from the operation circuit. The vector computation unit 1007 is mainly used for non-convolutional/FC-layer network computation in a neural network, for example, pooling (pooling), batch normalization (batch normalization), or local response normalization (local response normalization).

In some implementations, the vector computation unit 1007 can store, to the unified buffer 1006, a vector output through processing. For example, the vector computation unit 1007 may apply a nonlinear function to an output of the operation circuit 1003, for example, a vector of an accumulated value, to generate an activation value. In some implementations, the vector computation unit 1007 generates a normalized value, a combined value, or both a normalized value and a combined value. In some implementations, the vector output through processing (the vector processed by the vector computation unit 1007) may be used as activation input to the operation circuit 1003, for example, to be used in some layer(s) of the neural network.

The instruction fetch memory (instruction fetch buffer) 1009 connected to the controller 1004 is configured to store an instruction used by the controller 1004. The unified memory 1006, the input memory 1001, the weight memory 1002, and the instruction fetch memory 1009 are all on-chip memories. The external memory is independent from the hardware architecture of the NPU.

Operations at the layers of the neural networks (e.g. encoder and decoder layers) may be performed by the operation circuit 1003 or the vector computation unit 1007.

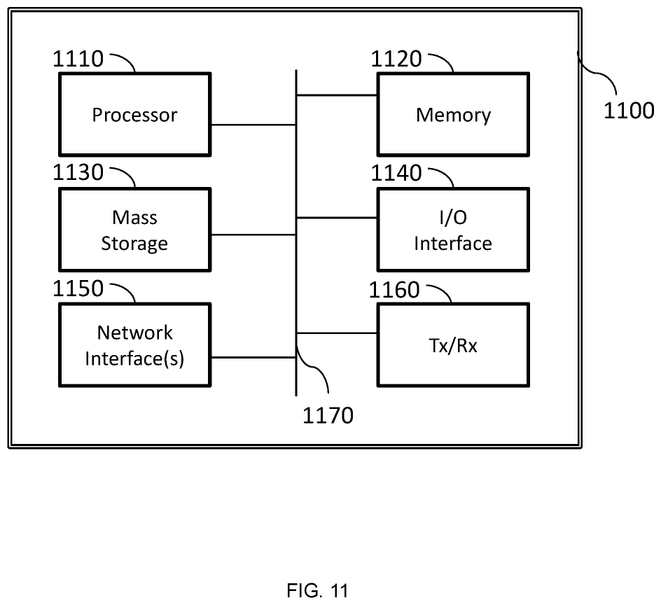

FIG. 11 is a schematic diagram of an electronic device 1100 that may perform any or all of operations of the above methods and features explicitly or implicitly described herein, according to different embodiments of the present disclosure. For example, a computer equipped with network function may be configured as an electronic device 1100. Such an electronic device may be used as part of one or more of: a controller, an edge server, a processing device, a bounding region module, an AV, an RSU, etc.

As shown, the device includes a processor 1110, such as a Central Processing Unit (CPU) or specialized processors such as a Graphics Processing Unit (GPU) or other such processor unit, memory 1120, non-transitory mass storage 1130, I/O interface 1140, network interface 1150, and a transceiver 1160, all of which are communicatively coupled via bi-directional bus 1170. According to certain embodiments, any or all of the depicted elements may be utilized, or only a subset of the elements. Further, the device 1100 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1120 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store data and machine executable program code. According to certain embodiments, the memory 1120 or mass storage 1130 may have recorded thereon statements and instructions executable by the processor 1110 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A communication network, comprising:
a first network element having a neural network (NN) encoder, the NN encoder configured to obtain, from the first network element, input data and to process the input data to obtain a latent representation of the input data, the input data being values of operational state variables of the communication network obtained at the first network element; and
a second network element configured to obtain the latent representation from the first network element, the second network element having a NN decoder configured to process the latent representation in accordance with a traffic engineering (TE) function to obtain a TE output.

2. The communication network of claim 1, wherein the operational state variables of the communication network include at least one of:
an availability of computing resources in the communication network,
a transmission bit rate in the communication network,
a packet size of packets transmitted in the communication network,
a utilization of a link in the communication network,
a delay in a flow in the communication network,
a delay in a link of the communication network,
a feature obtained from a packet header,
a metric obtained from a packet header,
a data flow, and
a traffic flow.

3. The communication network of claim 1, wherein the second network element is configured to modify at least one of the operational state variables of the communication network in accordance with the TE output.

4. The communication network of claim 1, wherein the TE output includes at least one of:
a prediction of traffic in the communication network, the prediction of the traffic including a prediction of one or more of the operational state variables;
a classification of the traffic in the communication network, the classification of the traffic including a classification of the at least one of the operational state variables;
traffic forwarding settings of the communication network;
nodal traffic control settings related to at least one of traffic conditioning, queue management, and scheduling of the communication network;
an anomaly in the communication network;
and
a recommendation of a setting of a parameter of the communication network.

5. The communication network of claim 1, wherein the latent representation is an initial latent representation, wherein:
the communication network comprises additional network elements each having a respective additional NN encoder configured to obtain, from a respective additional network element, an additional latent representation of respective additional input data, the respective additional input data being related to additional values of operational state variables of the communication network obtained at the respective additional network element, and
the second network element is configured to obtain the additional latent representations from the additional network elements, the second network element configured to process the additional latent representation and the initial representation in accordance with the TE function to obtain the TE output.

6. The communication network of claim 5, wherein:
the second network element is configured to obtain a concatenation of the initial latent representation with the additional latent representations, and
the second network element is configured to process the concatenation in accordance with the TE function to obtain the TE output.

7. The communication network of claim 1, wherein:
the communication network is an access network or a core network;
the first network element is one of: a user equipment, an access network equipment and a core network equipment; and
the decoder network element is one of: another user equipment, an access network equipment and a core network equipment.

8. A method, comprising, at a first network element a communication network:
obtaining a latent representation from a second network element of the communication network, the latent representation representing input data obtained at the second network element, the input data being values of operational state variables of the communication network;
processing the latent representation in accordance with a traffic engineering (TE) function to obtain a TE output.

9. The method of claim 8, wherein the operational state variables of the communication network include at least one of:
an availability of computing resources in the communication network,
a transmission bit rate in the communication network,
a packet size of packets transmitted in the communication network,
a utilization of a link in the communication network,
a delay in a flow in the communication network, and
a delay in a link of the communication network.

10. The method of claim 8, wherein the first network element is configured to modify at least one of the operational state variables of the communication network in accordance with the TE output.

11. The method of claim 8, wherein processing the latent representation in accordance with the TE function to obtain a TE output includes processing the latent representation in accordance with the TE function to obtain at least one of:
a prediction of one or more of the operational state variables,
a classification of at least one of the operational state variables, and
a recommendation of a setting of a parameter of the communication network.

12. The method of claim 8, wherein the latent representation is an initial latent representation, the method further comprising, at the first network element of the communication network:
obtaining additional latent representations from respective additional network elements of the communication network, the additional latent representations representing respective additional input data obtained at the respective additional network elements, the additional input data being additional values of operational state variables of the communication network wherein
processing the initial latent representation in accordance with the TE function to obtain the TE output includes processing the additional latent representations and the initial latent representation in accordance with the TE function to obtain the TE output.

13. The method of claim 12, further comprising obtaining a concatenation of the initial latent representation with the additional latent representations, wherein processing the additional latent representations and the initial latent representation in accordance with the TE function to obtain the TE output includes processing the concatenation in accordance with the TE function to obtain the TE output.

14. The method of claim 8, wherein the input data includes at least one of sensing data generated by a sensor coupled to the communication network and analytics data generated by an analytics module coupled to the communication network.

15. A method, comprising, at a first network element of a communication network:
obtaining input data of the communication network, the input data being values of operational state variables of the communication network;
encoding, using a neural network (NN) encoder, the input data to obtain a latent representation;
providing the latent representation to a second network element of the communication network, the second network element configured to process the latent representation, with a NN decoder, in accordance with a traffic engineering (TE) function to obtain a TE output.

16. The method of claim 15, wherein the operational state variables of the communication network include at least one of:
an availability of computing resources in the communication network,
a transmission bit rate in the communication network,
a packet size of packets transmitted in the communication network,
a utilization of a link in the communication network,
a delay in a flow in the communication network, and
a delay in a link of the communication network.

17. The method of claim 16, wherein the latent representation is an initial latent representation, the method further comprising, at additional network elements of the communication network:
obtaining additional input data of the communication network, the additional input data being additional values of operational state variables of the communication network;
encoding, using respective additional (NN) encoders, the additional input data to obtain additional latent representations;
providing the additional latent representations to the second network element of the communication network, the second network element configured to process the additional latent representation and the initial latent representation, with the NN decoder, in accordance with the TE function to obtain the TE output.

18. The method of claim 17, wherein the second network element is configured to obtain a concatenation of the initial latent representation with the additional latent representations, the second network element being configured to process the additional latent representation and the initial latent representation, with the NN decoder, in accordance with the TE function to obtain the TE output includes the second network element being configured to process the concatenation, with the NN decoder, in accordance with the TE function to obtain the TE output.

19. A tangible, non-transitory computer-readable medium having stored thereon instructions to be performed by a processor to perform the method of claim 8.

20. A tangible, non-transitory computer-readable medium having stored thereon instructions to be performed by a processor to perform the method of claim 15.
